(19) United States
(12) Patent Application Publication
(10) Pub. No.: US 2006/0022462 A1
(43) Pub. Date: Feb. 2, 2006

(54) Fitting for converting an ENT socket to a schedule 40 socket

(76) Inventors: Eric G. Hull, Madison, OH (US); Gregory D. Turcovsky, Mentor, OH (US); Dennis P. Revlock SR., Medina, OH (US)

Correspondence Address: STEPHEN D. SCANLON, JONES DAY, 901 LAKESIDE AVENUE, CLEVELAND, OH, 44114, US

(21) Appl. No.: 10/909,045

(22) Filed: Jul. 30, 2004

(51) Int. Cl. F16L 39/00

(52) U.S. Cl. 285/319

(57) ABSTRACT

A tubular fitting for connecting electrical conduit has opposite male and female end portions. The male end portion has a cylindrical outer surface with a pair of axially-spaced projections extending outwardly therefrom and is receivable in an existing ENT socket. The female end portion has a schedule 40 socket therein for receiving a schedule 40 conduit of the same trade size as the trade size of the ENT conduit that is receivable in the existing ENT socket.

### BACKGROUND

This application relates to the art of electrical fittings and, more particularly, to an electrical fitting in the form of a transition adapter having a barbed male end portion and an opposite end portion with a female socket therein for receiving an end portion of an electrical conduit. The application particularly concerns fittings for transitioning from an existing ENT socket to a piece of schedule 40 conduit and will be described with specific reference thereto. However, it will be appreciated that certain features of the fitting may be used for other purposes.

### SUMMARY

A fitting for electrical conduit is molded in one-piece of plastic material and has a barbed male end portion and a female socket on its opposite end portion.

The barbed male end portion has a pair of longitudinally-spaced circumferential rings projecting outwardly therefrom for cooperation with latch fingers on an existing female ENT socket.

A first of the rings on the barbed male end portion forms a barrier to block flow of concrete toward the end of the male end portion when the second ring is in locking engagement with a pair of opposite latch fingers on an ENT socket.

The female socket on the fitting is configured to receive an end portion of a schedule 40 conduit.

### BRIEF DESCRIPTION OF THE DRAWING

FIG. 1 is a perspective illustration of a fitting in accordance with the present application;

FIG. 2 is a side elevational view thereof;

FIG. 3 is an end elevational view thereof;

FIG. 4 is a cross-sectional elevational view taken generally on line 4-4 of FIG. 3;

FIG. 5 is a perspective illustration of the fitting of FIGS. 1-4 combined with a snap-in ENT adapter;

FIG. 6 is a cross-sectional elevational view of the fitting of FIGS. 1-4 received in an existing ENT socket; and

FIG. 7 is a cross-sectional elevational view similar to FIG. 6, but taken 90° from the section of FIG. 6.

### DESCRIPTION OF EMBODIMENTS

In this application, ENT is an acronym for electrical nonmetallic tubing of the type formed by a flexible corrugated tube that is made of plastic material such as PVC. Schedule 40 refers to rigid cylindrical PVC electrical conduit.

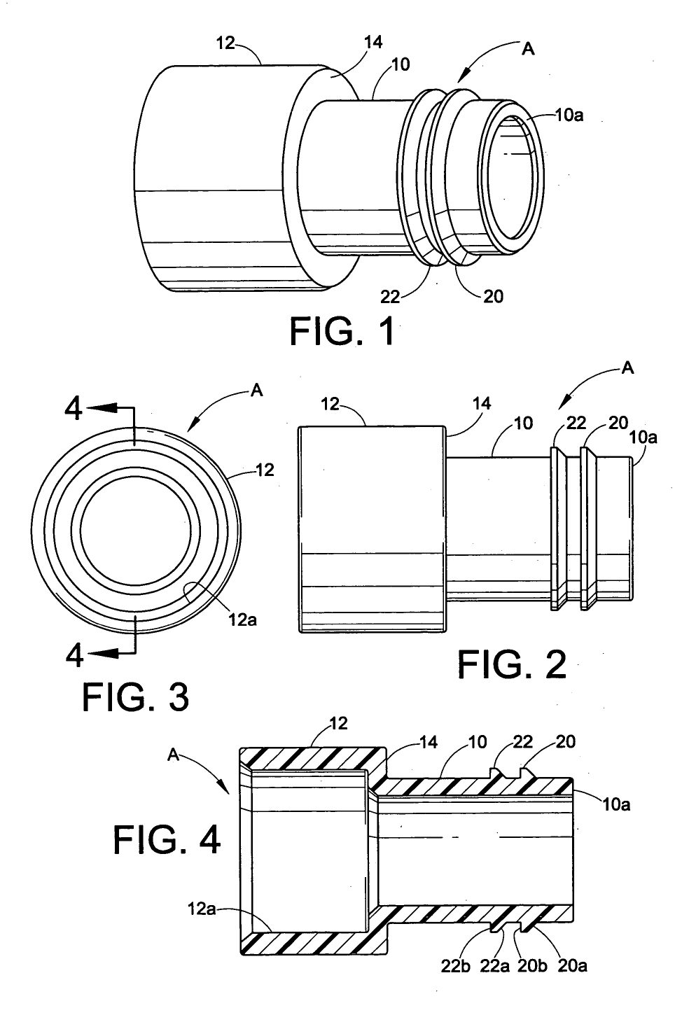

Referring now to the drawings, wherein the showings are for purposes of illustrating a representative embodiment only and not for purposes of limiting same, FIGS. 1-4 show a tubular fitting A that is molded in one-piece of plastic material and is configured for transitioning from an existing standard female ENT socket to a schedule 40 solvent cement socket.

Fitting A has a generally cylindrical barbed male end portion 10 and a generally cylindrical female socket end portion 12. Male and female end portions 10, 12 intersect at an external radial circumferential shoulder 14.

Female end portion 12 has a smooth walled cylindrical socket 12a therein that is configured for closely receiving an end portion of either a one-half inch, three-quarter inch or one inch schedule 40 PVC conduit. One-half inch trade size schedule 40 conduit has an average outside diameter of 0.840 inches. Three-quarter inch schedule 40 trade size schedule 40 conduit has an average outside diameter of 1.050 inches. One inch trade size schedule 40 conduit has an average outside diameter of 1.315 inches.

The inside diameter of schedule 40 PVC conduit depends on whether it is standard or heavy wall. Standard one-half inch, three-quarter inch and one inch schedule 40 conduit has an average inside diameter of 0.622 inches, 0.824 inches and 1.049 inches. Heavy wall schedule 40 conduit in one-half inch, three-quarter inch and one inch trade sizes has an average inside diameter of 0.60 inches, 0.80 inches and 1.03 inches. An end portion of a schedule 40 conduit that is received within socket 12a is solvent cemented therein in a known manner.

Barbed cylindrical male end portion 10 has a terminal end 10a. A pair of longitudinally-spaced circumferential rings 20, 22 project outwardly from the outer cylindrical surface of male end portion 10. Each ring has a sloping cam surface 20a, 22a that faces toward end 10a and an opposite radial surface 20b, 22b that faces toward shoulder 14. Both of rings 20, 22 are located closer to end 10a than to shoulder 14 and second ring 22 is located between shoulder 14 and first ring 20.

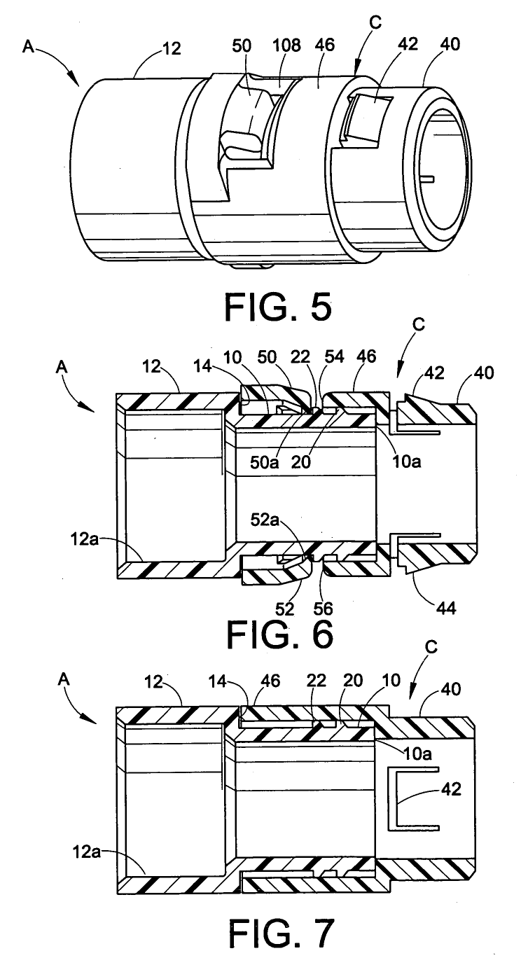

FIGS. 5-7 show a snap-in ENT adapter C having a cylindrical male end portion 40 and a pair of resilient opposite snap fingers 42, 44. Cylindrical end portion 40 is closely receivable through a circular hole in the wall of an outlet box or the like, and snap fingers 42, 44 snap through the hole for securing adapter C to the box wall. Adapter C has a standard female ENT socket portion 46. ENT socket 46 has opposite resilient latch fingers 50, 52 with hook end portions 50a, 52a that project into opposite openings 54, 56 in the peripheral wall of ENT socket 46.

Male end portion 10 on reducer fitting A is receivable in socket 46 on adapter C as shown in FIGS. 6 and 7, and ring 22 is shown locked behind hook end portions 50a, 52a on latch fingers 50, 52 to prevent removal of male end portion 10 from within socket 46. Openings 54, 56 in the peripheral wall of socket 46 normally provide a possible path for entry of poured concrete into socket 46 where it may flow along the clearance between the inner peripheral wall of the socket and the outer peripheral surface of male end portion 10 to enter the passage within the fittings.

In the configuration of the present application, ring projection 20 provides a barrier against the flow of concrete through openings 54, 56 to the interior of the fittings. Thus, ring projection 20 can have other configurations and does not require the same configuration as ring projection 22 when it is used solely as a barrier against the flow of concrete.

Sockets 46 may be of different depths, and ring projection 20 performs the same locking function as ring projection 22 when used with a shallower socket. In a shallower socket, ring projection 20 locks behind latch fingers 50, 52, hook end portions 50a, 52a on and ring projection 22 is on the opposite side of latch fingers 50, 52 from the position shown in FIG. 6. In that configuration, an additional projecting ring that forms a barrier against flow of concrete may be provided between ring projection 20 and the terminal end of 10a male end portion 10. It will be recognized that female socket 46 may be on a threaded adapter or on an ENT socket that is molded integrally with a box sidewall instead of being on a snap-in adapter.

Fitting A normally is configured for transitioning from an existing ENT socket of one size to a piece of schedule 40 conduit of the same size. For example, male end portion 10 of fitting A may be configured for locking reception within an ENT socket that is configured for receiving a one inch trade size ENT tube. Schedule 40 socket 12a then is configured for also receiving an end portion of a one inch trade size schedule 40 conduit. The same arrangement is provided for other sizes of fitting A.

Male end portion 10 on fitting A is configured for reception in a one-half inch trade size ENT socket, a three-quarter inch trade size ENT socket or a one inch trade size ENT socket. It will be recognized that other sizes also can be provided. One-half inch trade size ENT tubing has an outside diameter of 0.832-0.848 inches. Three-quarter inch trade size ENT tubing has an outside diameter of 1.040-1.060 inches. One inch trade size ENT tubing has an outside diameter of 1.305-1.325 inches.

The length of male end portion 10 of fitting A from terminal end 10a to shoulder 14 is approximately 0.940 inches. Radial rear surface 20b is spaced approximately 0.260 inches from terminal end 10a. Radial rear surface 22b on ring projection 22 is spaced approximately 0.410 inches from terminal end 10a. Thus, projections 20 and 22 are located much closer to terminal end 10a, 50a than to shoulder 14.

Although the improvements of this application have been shown and described with reference to a representative embodiment, it is obvious that alterations and modifications will occur to others skilled in the art upon the reading and understanding of this disclosure. Therefore, it is to be understood that the improvements may be practiced otherwise than as specifically described herein while remaining within the scope of the claims.

1. A transition fitting for transitioning from an existing ENT socket to a piece of schedule 40 conduit, said fitting having generally cylindrical male and female opposite end portions, said male end portion having a cylindrical outer surface and a terminal end, a shoulder extending outwardly from said outer surface between said male and female end portions, a pair of axially-spaced first and second circumferential projections extending outwardly from said outer surface intermediate said terminal end and said shoulder, said second projection being located between said first projection and said shoulder, at least said second projection having a sloping cam surface that slopes outwardly from said outer surface in a direction away from said terminal end, and said female end portion having a generally cylindrical socket therein for receiving an end portion of an electrical conduit.

2. The fitting of claim 1 wherein said first projection has a sloping cam surface that slopes outwardly from said outer surface in a direction away from said terminal end.

3. The fitting of claim 1 wherein both of said projections have the same configuration and size.

4. The fitting of claim 1 wherein said generally cylindrical socket is a schedule 40 solvent cement socket.

5-8. (canceled)

9. The fitting of claim 1 wherein said fitting is molded in one-piece of plastic material.

10. The fitting of claim 1 wherein said pair of projections are located so that said cylindrical outer surface extends between said projections and said shoulder, between said projections and said terminal end and between said pair of projections themselves.

11. The fitting of claim 1 wherein said pair of circumferential projections have the same configuration.

12. The fitting of claim 1 wherein said cylindrical outer surface on said male end portion extends continuously from said shoulder to said terminal end of said male end portion and said pair of circumferential projections extend outwardly from the same said cylindrical outer surface.

13. The fitting of claim 12 wherein said pair of circumferential projections have the same configuration.

14. A transition fitting for transitioning from an existing female ENT socket to a piece of schedule 40 conduit, said fitting having generally cylindrical male and female opposite end portions, said male end portion having a cylindrical outer surface and a terminal end, a shoulder extending outwardly from said outer surface between said male and female end portions, at least one circumferential projection extending outwardly from said outer surface intermediate said terminal end and said shoulder so that said cylindrical outer surface extends between said projection and said shoulder and between said projection and said terminal end, said projection having a sloping cam surface that intersects said cylindrical outer surface and slopes outwardly from said outer surface in a direction away from said terminal end, and said female end portion having a generally cylindrical schedule 40 socket therein.

15. The fitting of claim 14 wherein said male end portion is configured for reception in an ENT socket for a predetermined trade size of ENT conduit, and said schedule 40 socket is configured for receiving the same predetermined trade size of schedule 40 conduit.

16. The fitting of claim 14 wherein said male end portion has a length greater than the depth of said schedule 40 socket.

17. The fitting of claim 14 wherein said fitting is molded in one-piece of plastic material.

18. A transition fitting for transitioning from an existing electrical nonmetallic tubing socket to a piece of rigid cylindrical plastic electrical conduit, said fitting having generally cylindrical male and female opposite end portions, said male end portion having a cylindrical outer surface and a terminal end, a shoulder extending outwardly from said outer surface between said male and female end portions, a pair of axially-spaced first and second circumferential projections extending outwardly from said outer surface intermediate said terminal end and said shoulder, said second projection being located between said first projection and said shoulder, at least said second projection having a sloping cam surface that slopes outwardly from said outer surface in a direction away from said terminal end, and said female end portion having a generally cylindrical socket therein for receiving an end portion of an electrical conduit.

19. The fitting of claim 18 wherein said first projection has a sloping cam surface that slopes outwardly from said outer surface in a direction away from said terminal end.

20. The fitting of claim 18 wherein said fitting is molded in one piece of plastic material.

21. The fitting of claim 18 wherein both of said projections have the same configuration and size.

22. The fitting of claim 18 wherein said generally cylindrical socket socket is a solvent cement socket.

23. The fitting of claim 18 wherein said pair of projections are located so that said cylindrical outer surface extends between said projections and said shoulder, between said projections and said terminal end and between said pair of projections themselves.

24. The fitting of claim 18 wherein said pair of circumferential projections have the same configuration.

25. The fitting of claim 18 wherein said cylindrical outer surface on said male end portion extends continuously from said shoulder to said terminal end of said male end portion and said pair of circumferential projections extend outwardly from the same said cylindrical outer surface.

26. The fitting of claim 25 wherein said pair of circumferential projections have the same configuration.

27. A transition fitting for transitioning from an existing female electrical nonmetallic tubing socket to a piece of rigid cylindrical plastic electrical conduit, said fitting having generally cylindrical male and female opposite end portions, said male end portion having a cylindrical outer surface and a terminal end, a shoulder extending outwardly from said outer surface between said male and female end portions, at least one circumferential projection extending outwardly from said outer surface intermediate said terminal end and said shoulder so that said cylindrical outer surface extends between said projection and said shoulder and between said projection and said terminal end, said projection having a sloping cam surface that intersects said cylindrical outer surface and slopes outwardly from said outer surface in a direction away from said terminal end, and said female end portion having a generally cylindrical socket therein for receiving a rigid cylindrical plastic electrical conduit.

28. The fitting of claim 27 wherein said male end portion is configured for reception in an electrical nonmetallic tubing socket for a predetermined size of electrical nonmetallic tubing, and said socket for receiving a rigid cylindrical plastic electrical conduit is configured for receiving the same predetermined size of rigid cylindrical plastic electrical conduit.

29. The fitting of claim 27 wherein said male end portion has a length greater than the depth of said for receiving a rigid cylindrical plastic electrical conduit socket.

30. The fitting of claim 27 wherein said fitting is molded in one piece of plastic material.
